(19) United States
(12) Patent Application Publication
(10) Pub. No.: US 2019/0004362 A1
(43) Pub. Date: Jan. 3, 2019

(54) Display Assembly and Display Device

(71) Applicant: BOE TECHNOLOGY GROUP CO., LTD., Beijing (CN)

(72) Inventor: Chengbin WEI, Beijing (CN)

(73) Assignee: Boe Technology Group Co., Ltd., Beijing (CN)

(21) Appl. No.: 15/752,349

(22) PCT Filed: Jan. 3, 2017
(86) PCT No.: PCT/CN2017/000028

§ 371 Date: Feb. 13, 2018

(30) Foreign Application Priority Data
Apr. 8, 2016 (CN) 201620291349.X

(51) Int. Cl. G02F 1/1333

(52) U.S. Cl. CPC G02F 1/133308; G02F 2001/133317; G02F 1/1336; G02F 2201/46; G02F 2001/13332

(57) ABSTRACT

The present application provides a display assembly and a display device, the display assembly comprising a backlight assembly and a display panel, wherein the backlight assembly comprises a bezel and a mold frame, the mold frame is fixedly connected with a non-display region of the display panel, the bezel comprises a side frame part and a front frame part integrated with the side frame part, the side frame part is located on a side of the mold frame, the front frame part is located in front of the mold frame, the side frame part and the front frame part package the mold frame, a front surface of the front frame part is provided with a connection structure which extends to the non-display region of the display panel, the connection structure is fixedly connected with the front surface of the front frame part and a front surface of the display panel.

This is a National Phase Application filed under 35 U.S.C. 371 as a national stage of PCT/CN2017/000028, filed Jan. 3, 2017, an application claiming the benefit of Chinese Application No. 201620291349.X, filed Apr. 8, 2016, the content of each of which is hereby incorporated by reference in its entirety.

### TECHNICAL FIELD

The present disclosure relates to the field of display technology, and particularly to a display assembly and a display device.

### BACKGROUND

With the development of display technology, liquid crystal display devices have been widely applied by people, and are playing a crucial role in industrial production and people's lives. The present application provides a display assembly and a display device, wherein the display assembly and a display panel can be fixed firmly.

### SUMMARY

The present application provides a display assembly and a display device, which can solve the problem that the display panel in the prior art cannot be fixed firmly.

In order to achieve the above object, provided is a display assembly comprising a backlight assembly and a display panel, wherein the backlight assembly comprises a bezel and a mold frame, the mold frame is fixedly connected with a non-display region of the display panel, the bezel comprises a side frame part and a front frame part integrated with the side frame part, the side frame part is located on a side of the mold frame, the front frame part is located in front of the mold frame, the side frame part and the front frame part are configured to package a circumference of the mold frame, and wherein

a front surface of the front frame part is provided with a connection structure, and the connecting structure extends to the non-display region of the display panel, and the connection structure is fixedly connected with the front surface of the front frame part and a front surface of the display panel.

Optionally, a cross section of the connection structure is of an L shape.

Optionally, a portion of the connection structure located on the front frame part has a width of 4.5 mm;

the portion of the connection structure located on the front frame part has a thickness of 0.4 mm;

a portion of the connection structure located on the display panel has a width of 1.0 mm; and

the portion of the connection structure located on the display panel has a thickness of 1.5 mm.

Optionally, a gap exists between the front frame part and the display panel, and the connection structure extends into the gap.

Optionally, a cross section of the connection structure is of a U shape.

Optionally, a portion of the connection structure located on the front frame part has a width of 4.5 mm;

the portion of the connection structure located on the front frame part has a thickness of 0.4 mm;

a portion of the connection structure located on the display panel has a width of 1.9 mm; and

a portion of the connection structure located on the display panel but not in the gap has a thickness of 1.5 mm; and

a portion of the connection structure located on the display panel and in the gap has a thickness of 0.4 mm.

Optionally, the connection structure is fixedly connected with a front surface of the front frame part and a front surface of the display panel through adhesive.

Optionally, a surface of the connection structure is a glossy black surface.

Optionally, the connection structure is made of PET or silica gel, and is formed with a glossy black surface.

In order to achieve the above object, provided is a display device, comprising the above display assembly.

Optionally, the display device further comprises a house provided outside of the bezel.

Optionally, the house is in contact with the connection structure.

### BRIEF DESCRIPTION OF THE DRAWINGS

FIG. 1 is a structural diagram of an existing display assembly;

FIG. 2 is a structural diagram of a display assembly in a first embodiment according to the present application;

FIG. 3 is a diagram illustrating a connection structure of FIG. 2;

FIG. 4 is a diagram illustrating a case where light leakage occurs in a peripheral region of an existing display panel;

FIG. 5 is a diagram illustrating a case where light at the peripheral region of the display panel is blocked by using a connection structure in an embodiment according to the present application;

FIG. 6 is a structural diagram of a display assembly in a second embodiment according to the present application;

FIG. 7 is a diagram illustrating a connection structure of FIG. 6;

FIG. 8 is a structural diagram of a display device in a third embodiment according to the present application.

### DETAILED DESCRIPTION

In order to make a person skilled in the art understand solutions of the present application better, a display assembly and a display panel provided in the present application will be described in detail below in conjunction with the accompanying drawings.

Display assembly is a main component in the liquid crystal display device. FIG. 1 is a structural diagram of an existing display assembly. As shown in FIG. 1, the display assembly comprises a backlight assembly and a display panel 3. The backlight assembly comprises: a bezel 1 and a mold frame 2. The mold frame 2 is fixedly connected with a non-display region of the display panel 3. The bezel 1 comprises a side frame part 101 and a front frame part 102 integrated with the side frame part 101, the side frame part 101 is located on a side of the mold frame 2, the front frame part 102 is located in front of the mold frame 2, and the side frame part 101 cooperates with the front frame part 102 to package a circumference of the mold frame 2, so that the whole display assembly is more strong and attractive.

In a practical application, because the display panel 3 is bonded to the mold frame 2 by double-sided adhesive, with the increase of using time, bonding fastness between the the display panel 3 and the mold frame 2 will be getting worse. Once a vibration occurs, bonding between the display panel 3 and the mold frame 2 is easily loosened and a relative displacement may be occur between the display panel 3 and the mold frame 2, so that a fraction is prone to be produced between the display panel 3 and a optical film material 4 close to the display panel 3, which leads to poor display.

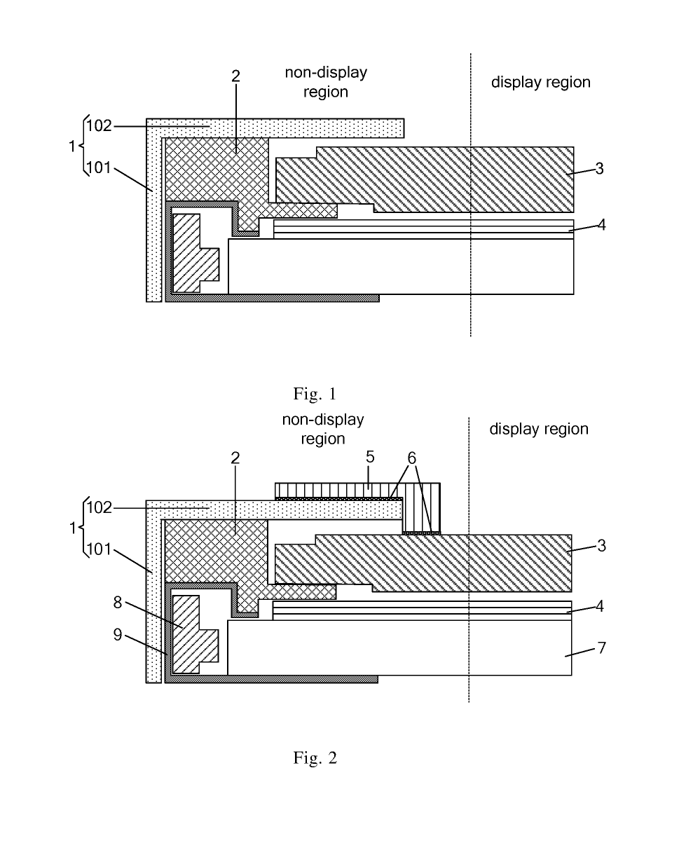

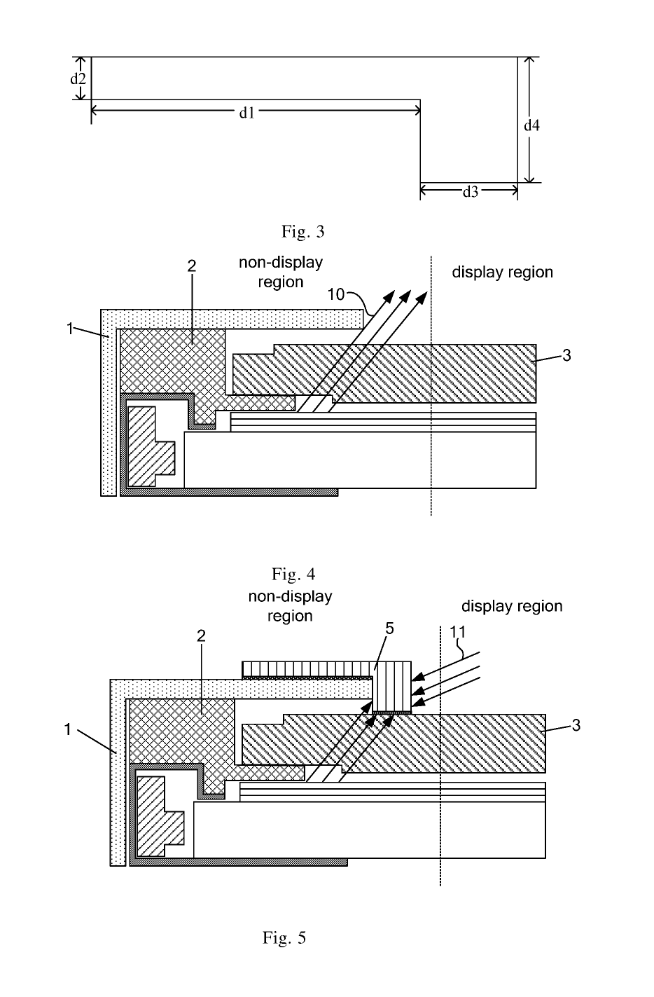

FIG. 2 is a structural diagram of a display assembly in a first embodiment according to the present application, and FIG. 3 is a diagram illustrating a connection structure of FIG. 2. As shown in FIGS. 2 and 3, the display assembly mainly comprises a backlight assembly and a display panel 3, wherein the backlight assembly comprises a bezel 1 and a mold frame 2, the mold frame 2 is fixedly connected with a non-display region of the display panel 3, and the bezel 1 comprises a side frame part 101 and a front frame part 102 integrated with the side frame part 101. For example, the side frame part 101 and the front frame part 102 in the figures may be formed by folding a strip bezel body into an L shape. The side frame part 101 is located on a side of the mold frame 2, the front frame part 102 is located in front of the mold frame 2, the side frame part 101 and the front frame part 102 are configured to package a circumference of the mold frame 2. A front surface of the front frame part 102 is provided with a connection structure 5, the connecting structure 5 extends to the non-display region of the display panel 3, and the connection structure 5 is fixedly connected with the front surface of the front frame part 102 and a front surface of the display panel 3 through adhesive 6.

It should be noted that, terms “front surface” and “rear surface” in the embodiment means two opposite surfaces of a corresponding structure, and the “front surface” refers to one surface of the corresponding structure having a same orientation as that of a light outgoing side of the display panel 3, that is, the upper surface of each structure in the drawings.

Compared with the prior art, the display panel 3 in the present embodiment is not only fixedly connected with the mold frame 2, but also fixedly connected with the bezel 1 through the connection structure 5, therefore, in the present embodiment, the display panel 3 and the backlight assembly are assembled more firmly, which can effectively avoid the displacement of the display panel 3 relative to the backlight assembly, thereby reducing the incidence of poor display.

As an implementation in the present embodiment, a cross section of the connection structure 5 is of an L shape. A portion of the connection structure 5 located on the front frame part 102 has a width d1 of 4.5 mm and a thickness d2 of 0.4 mm. A portion of the connection structure 5 located on the display panel 3 has a width d3 of 1.0 mm and a thickness d4 of 1.5 mm.

It should be noted that, the above connection structure 5 is a preferable solution in the present embodiment, which can provide an excellent fixed connection between the display panel 3 and the bezel 1 without affecting the assembling of the display panel 3 and the display effect. A person skilled in the art should know that the specific structure of the above connection structure 5 is only illustrative, but not to limit the solution of the present application. In a practical application, the dimensions of portions of the connection structure 5 may be adjusted accordingly as needed.

FIG. 4 is a diagram illustrating a case where light leakage occurs in a peripheral region of an existing display panel. As shown in FIG. 4, in the prior art, with the development of the narrow bezel design, the dimensions of the front frame part 102 of the bezel 1 are reduced, so that light 10 at the periphery region (non-display region) of the display panel 3 can emit out from the front frame part 102, causing light leakage at the periphery region of the display panel 3. With the improvement of the connection structure in the above embodiment of the present application, the problem of light leakage can be effectively solved. For example, FIG. 5 shows a case where the light at the peripheral region of the display panel is blocked by the connection structure 5 in the embodiment according to the present application. As shown in FIG. 5, the surface of the connection structure 5 is configured to be a black surface which is opaque, the light 10 can be prevented from emitting from the periphery region of the display panel 3, so that the light leakage problem of the periphery region of the display panel 3 can be effectively solved. Furthermore, in the present embodiment, the surface of the connection structure 5 may be configured to be a glossy black surface, so that external light 11 cannot be diffused on the surface of the connection structure 5 (the weaker the diffuse reflection effect is, the worse the imaging effect is, and the better the invisibility of the connection structure 5 is); therefore, the connection structure 5 cannot be easily perceived by users, thus ensuring the user's better experience.

It can be seen from above that, the connection structure 5 with the glossy black surface in the present embodiment can not only fix the display panel but also prevent light leakage of the display panel.

In the present embodiment, optionally, the material of the connection structure 5 having the glossy black surface may be polyethylene terephthalate (PET). Since PET is not likely to be deformed by stretching, thus PET has a good fixing effect. Alternatively, the material of the connection structure 5 having the glossy black surface is silica gel, which has a good damping effect and can improve the anti-vibration effect of the whole display assembly, and is applicable to some occasions such as bus and subway, which have high anti-vibration requirement.

It should be noted that, in the present embodiment, the connection structure 5 being formed of PET or silica gel is only illustrative, but not to limit the solutions of the present application, a person skilled in the art should know that corresponding material can be selected depending on the using environment, and the specific situations will no be enumerated here.

In addition, the display assembly in the present embodiment further comprises a light guide plate 7, an optical film layer 4, a light source 8, a back plate 9, etc., which are the same as those in the prior art and are not described in detail here.

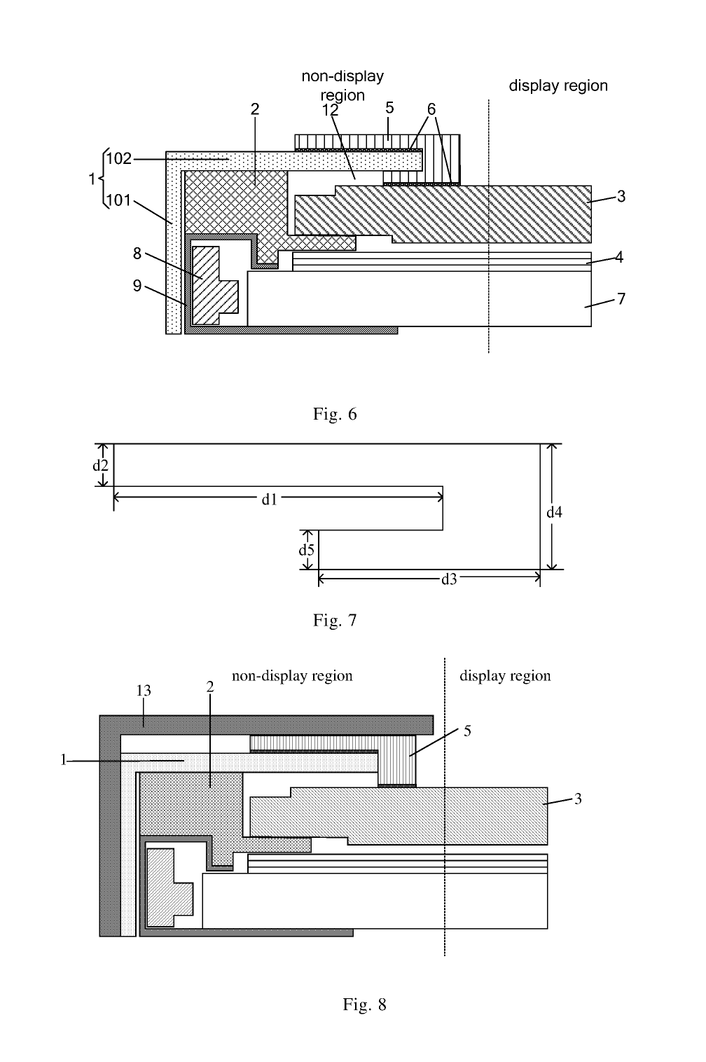

FIG. 6 is a structural diagram of a display assembly in a second embodiment according to the present application, and FIG. 7 is a structural diagram illustrating a connection structure of FIG. 6. As shown in FIGS. 6 and 7, the display assembly in the present embodiment is different from that in the first embodiment in that, the connection structure 5 in the present embodiment further extends into a gap 12 between the front frame part 102 and the display panel 3.

In the present embodiment, in a case where the connection structure 5 extends into the gap 12, a contact area between the connection structure 5 and the display panel 3 can be effectively increased without affecting the display effect of the display panel 3, therefore, the fastness of the connection between the connection structure 5 and the display panel 3 can be enhanced.

Optionally, a cross section of the connection structure 5 in the present embodiment is of a U shape as shown in FIGS. 6 and 7. A portion of the connection structure 5 located on the front frame part 102 has a width d1 of 4.5 mm and a thickness d2 of 0.4 mm, a portion of the connection structure 5 located on the display panel 3 has a width d3 of 1.9 mm, a portion of the connection structure 5 located on the display panel 3 but not in the gap 12 has a thickness d4 of 1.5 mm, and a portion of the connection structure 5 located on the display panel 3 and in the gap 12 has a thickness d5 of 0.4 mm.

It should be noted that, the above connection structure 5 with a cross section of U shape is a preferable solution in the present application, which can provide an excellent fixed connection between the display panel 3 and the bezel 3 without affecting the assembling of the display panel 3 and the display effect. A person skilled in the art should know that the specific structure of the above connection structure 5 is only illustrative, but not to limit the solution of the present application. In a practical application, the dimensions of portions of the connection structure 5 may be adjusted accordingly as needed.

FIG. 8 is a structural diagram of a display device in a third embodiment according to the present application. As shown in FIG. 8, the display device comprises a display assembly, which is the one in the first embodiment or the second embodiment, specific contents of which can refer to descriptions in the first and second embodiments and will not be described again here.

Optionally, the display device further comprises a house 13, which is provided outside of the bezel 1. The house 13 can not only improve the appearance of the display device but also effectively protect the display assembly.

It should be noted that, the connection structure 5 can further enhance the protection effect of the house 13 to the backlight assembly and the display panel 3. Specifically, after the house is assembled, the connection structure 5 exists between the house 13 and the front frame part 102 of the bezel 1. In a case where the house 13 is subjected to an external force, most of the energy will be absorbed by the connection structure 5, and the energy transferred to the backlight assembly and the display panel 3 is less, so that a damage to the backlight assembly and the display panel 3 can be effectively avoided.

In summary, the present application has the following advantages:

The present application provides a display assembly and a display device, the display assembly comprising a backlight assembly and a display panel, wherein the backlight assembly comprises a bezel and a mold frame, the mold frame is fixedly connected with a non-display region of the display panel, the bezel comprises a side frame part and a front frame part integrated with the side frame part, the side frame part is located on a side of the mold frame, the front frame part is located in front of the mold frame, the side frame part and the front frame part are configured to package a circumference of the mold frame, and wherein a front surface of the front frame part is provided with a connection structure, the connection structure extends to the non-display region of the display panel, and the connection structure is fixedly connected with the front surface of the front frame part and a front surface of the display panel through adhesive. In the display assembly in the present application, the display panel is not only fixedly connected with the mold frame, but also fixedly connected with the bezel through the connection structure, thereby the firmness of the assembling between the display panel and the backlight assembly can be improved significantly, which can effectively avoid the displacement of the display panel relative to the backlight assembly, thereby reducing the incidence of poor display.
It should be understood that, the foregoing embodiments are only exemplary embodiments used for explaining the principle of the present invention, but the present invention is not limited thereto. Various variations and improvements may be made by a person skilled in the art without departing from the spirit and essence of the present invention, and these variations and improvements also fall into the protection scope of the present invention.

1-12. (canceled)

13. A display assembly comprising a backlight assembly and a display panel, wherein
the backlight assembly comprises a bezel and a mold frame, the mold frame is fixedly connected with a non-display region of the display panel, the bezel comprises a side frame part and a front frame part integrated with the side frame part, the side frame part is located on a side of the mold frame, the front frame part is located in front of the mold frame, the side frame part and the front frame part are configured to package a circumference of the mold frame, and wherein
a front surface of the front frame part is provided with a connection structure, and the connecting structure extends to the non-display region of the display panel, and the connection structure is fixedly connected with the front surface of the front frame part and a front surface of the display panel.

14. The display assembly of claim 13, wherein a cross section of the connection structure is of an L shape.

15. The display assembly of claim 14, wherein
a portion of the connection structure located on the front frame part has a width of 4.5 mm;
the portion of the connection structure located on the front frame part has a thickness of 0.4 mm;
a portion of the connection structure located on the display panel has a width of 1.0 mm; and
the portion of the connection structure located on the display panel has a thickness of 1.5 mm.

16. The display assembly of claim 13, wherein a gap exists between the front frame part and the display panel, and the connection structure extends into the gap.

17. The display assembly of claim 16, wherein a cross section of the connection structure is of a U shape.

18. The display assembly of claim 17, wherein
a portion of the connection structure located on the front frame part has a width of 4.5 mm;
the portion of the connection structure located on the front frame part has a thickness of 0.4 mm;
a portion of the connection structure located on the display panel has a width of 1.9 mm; and
a portion of the connection structure located on the display panel but not in the gap has a thickness of 1.5 mm; and
a portion of the connection structure located on the display panel and in the gap has a thickness of 0.4 mm.

19. The display assembly of claim 13, wherein the connection structure is fixedly connected with a front surface of the front frame part and a front surface of the display panel through adhesive.

20. The display assembly of claim 14, wherein the connection structure is fixedly connected with a front surface of the front frame part and a front surface of the display panel through adhesive.

21. The display assembly of claim 15, wherein the connection structure is fixedly connected with a front surface of the front frame part and a front surface of the display panel through adhesive.

22. The display assembly of claim 13, wherein a surface of the connection structure is a glossy black surface.

23. The display assembly of claim 14, wherein a surface of the connection structure is a glossy black surface.

24. The display assembly of claim 15, wherein a surface of the connection structure is a glossy black surface.

25. The display assembly of claim 19, wherein a surface of the connection structure is a glossy black surface.

26. The display assembly of claim 13, wherein the connection structure is made of PET or silica gel, and is formed with a glossy black surface.

27. The display assembly of claim 14, wherein the connection structure is made of PET or silica gel, and is formed with a glossy black surface.

28. The display assembly of claim 15, wherein the connection structure is made of PET or silica gel, and is formed with a glossy black surface.

29. The display assembly of claim 25, wherein the connection structure is made of PET or silica gel, and is formed with a glossy black surface.

30. A display device, comprising the display assembly of claim 13.

31. The display device of claim 30, further comprises a house provided outside of the bezel.

32. The display device of claim 31, wherein the house is in contact with the connection structure.
